(19) United States
(12) Patent Application Publication
(10) Pub. No.: US 2016/0325442 A1
(43) Pub. Date: Nov. 10, 2016

(54) KNIFE

(71) Applicant: MARTOR KG, Solingen (DE)

(72) Inventor: Martin HERLITZ, Remscheid (DE)

(21) Appl. No.: 15/142,271

(22) Filed: Apr. 29, 2016

(30) Foreign Application Priority Data
May 8, 2015 (DE) 102015005768.5

(51) Int. Cl. B26B 1/08; B26B 1/10

(52) U.S. Cl. CPC B26B 1/08; B26B 1/10

(57) ABSTRACT

The invention refers to a knife having a housing (11, 111) and an actuator (13, 116) for moving a blade holder (14) or a blade guard (113) between at least one safety position and at least one cutting position, the actuator (13, 116) having a handle (12, 117) whose is transmissible to the blade holder (14) or to the blade guard (113) by the actuator (13, 116) that has a first actuation surface (23, 123) associated with the handle (12, 117) and a second actuation surface (19, 125) associated with the blade holder (14) or the blade guard (113).

The novelty consists in that one of the actuation surfaces (19, 125) acts as a control surface with at least two different control parts (20, 21, 126, 127).

The invention relates to a knife.

The knife has a housing and a blade. The blade is supported in a blade holder that is for example movable in the housing between at least one safety position and at least one cutting position. In the safety position, the blade holder is retracted inside the housing so that the blade supported by the blade holder is inaccessible to the user. In the cutting position, the blade projects from the housing. The blade holder may perform a straight-line, rotational or a combined movement with straight-line and rotational components between the safety position and the cutting position.

According to an alternative embodiment of the knife, the blade is immovably or movably supported on the housing. A blade guard is movable with respect to the blade between a safety position and a cutting position. In the safety position, the blade guard extends over a cutting edge to prevent the user from getting injured by it. In the cutting position, the blade guard is moved away from the cutting edge and it is possible to carry out a cutting operation. The blade guard may move in a straight line, rotationally or through a combined movement with a straight-line and rotational components between the safety position and the cutting position.

The blade holder and/or the blade guard may be moved into the cutting position by an actuator. The actuator has a handle and, possibly, a force-transmitting structure. The force-transmitting structure may comprise one or more parts that transmit the movement of the handle to the blade holder or to the blade guard. A first actuation surface is associated with the handle. The first actuation surface is directly or indirectly provided on the handle, for example. “Indirectly provided on the handle” means, for example, that the actuation surface may also be provided on a separate part that is actively connected with the handle. This may be a part of the force-transmitting structure, for example.

A second actuation surface is associated with the blade holder or guard. The second actuation surface is directly or indirectly provided on the blade holder or guard, for example. “Indirectly provided on the blade holder or guard” means, for example, that the actuation surface may also be provided on a separate part that is actively connected with the blade holder or with the blade guard. This may be a part of the force-transmitting structure, for example.

The first actuation surface contacts the second actuation surface during movement between the safety position and the cutting position.

Such a knife is described in US 2003/0154606 [U.S. Pat. No. 6,813,833}, for example. In this case, the handle has a projection that interacts with an actuation surface of the blade holder in order to move the blade holder from the safety position to the cutting position.

The object of the invention is to further develop the knife, to provide an optimal actuation with a uniform or ergonomically advantageous effort.

The object is achieved by a knife having the characteristics of claim 1.

When the blade holder is in the safety position, actuation of the handle is necessary to move it into the first cutting position. The first and second actuation surfaces may already be engaged with each other or are moved into contact with each other following movement of the handle. During movement of the handle, the first actuation surface is moved with respect to the second actuation surface, and both actuation surfaces are in contact with each other. During relative movement of the actuation surfaces, the blade holder or guard are moved from the safety position to the cutting position.

According to the invention, in a first part for example one of the actuation surfaces is formed such that a predetermined movement of the handle relative to the housing causes a first forward movement of the blade holder or of the blade guard. The first forward movement is short, for example, when serving for starting movement of the system composed of the handle, the force-transmitting structure and the blade holder or guard.

In a second part, the actuation surface is arranged such that a predetermined movement of the handle relative to the housing causes a second forward movement of the blade holder or guard. The second forward movement differs from the first forward movement. In particular, the second forward movement is longer than the first forward movement, and the force required in the second forward movement for the relative movement of the handle is smaller than in the first forward movement.

The principle of the invention is based on the fact that the actuation surface formed by a control surface has at least one first part and one second part to vary the force-stroke or transmission ratio between the handle and the blade holder or guard varies movement between the safety position and the cutting position. The forward movement of the blade holder depends on the inclination of the actuation surface that acts as a control surface, with respect to the other actuation surface.

The invention may be used, for example, for reducing the initial resistance during the actuation of the knife. The blade holder or the guard holder has sliding surfaces that, when moving between the safety position and the first cutting position, contact counter-surfaces of the housing. In order to move the blade holder or guard by means of the handle from the safety position, it is necessary to overcome, for example, the forces due to static friction. Static friction exists, for example, between the blade holder or guard and the housing, between the force-transmitting structure and the housing as well as between the first actuation surface and the second actuation surface. This leads to a relatively high resistance at the beginning of the handle's movement.

When the static friction has been overcome and the blade holder or guard is set into motion, sliding friction is present between the contact surfaces so that the resistance to movement of the handle is lower. According to the invention, the control surface in the first part may be configured so that the actuation force, despite the higher initial resistance, is low. In a second part, the control surface may be configured in such a way that, after the initial resistance has been overcome, and sliding friction has set in, the force/stroke or transmission ratio is different from that of the first part. The actuation force of the handle in the second part may, for example, remain unchanged with respect to the first part, and in the second part, the forward movement of the blade holder or the guard holder is longer than with respect to the first part.

According to an embodiment, at least one part of the control surface is formed by a curve. The curve has different slopes, and that means that the force component acting on the second actuation surface and provided for moving the blade holder or guard varies along the first part.

In at least one part of the control surface, the control surface is straight, for example. In a straight part, the active force component for moving the blade holder or blade guard is constant. The control surface has at least two straight parts, for example that have different slopes. The straight parts form an angle β<180°.

The control surface may also comprise combinations, with at least one part being a curve and at least one part being straight. At the intersection between the two straight parts, for example that form an angle β<180°, the control surface may be a curve that tangentially merges with the straight parts. This ensures that during actuation there is a smooth transition, almost imperceptible to the user, from the first part to the second part.

The handle is pivotally mounted, for example. The handle may be pivotally mounted on the housing, for example. The handle is then moved between the unactuated and the actuated position. According to an alternative embodiment, the handle is mounted on the housing for movement in a straight line. In this case, the handle is moved between the unactuated and the actuated position. The handle may also carry out a combined movement with respect to the housing, for example that forms the straight-line and the rotational components. One part of the handle or a part movably connected with the handle forms an actuation surface, for example.

The blade holder or guard are spring-biased into the safety position, for example. The blade holder is moved by the spring into the safety position when the user no longer exerts a force on the handle or when the connection between the handle and the blade holder or guard is released. The second actuation surface is held in contact with the first actuation surface by the spring or by a separate spring, for example. The handle may also be urged by the spring into the unactuated position, for example.

There is sliding contact between the first actuation surface and the second actuation surface for example. During movement of the handle from the unactuated to the actuated position, the blade holder or guard is moved from the safety to the cutting position. At the same time, the first actuation surface slides on the second actuation surface. According to an alternative, the first actuation surface and/or the second actuation surface may also be provided with a roller bearing that rolls over the respective other surface.

The actuation surface that interacts with the control surface, may have a convex, in particular a domed shape, so that there is point contact between the first actuation surface and the second actuation surface.

Further advantages may be seen from an illustrated embodiment that is schematically shown in figures. Therein:

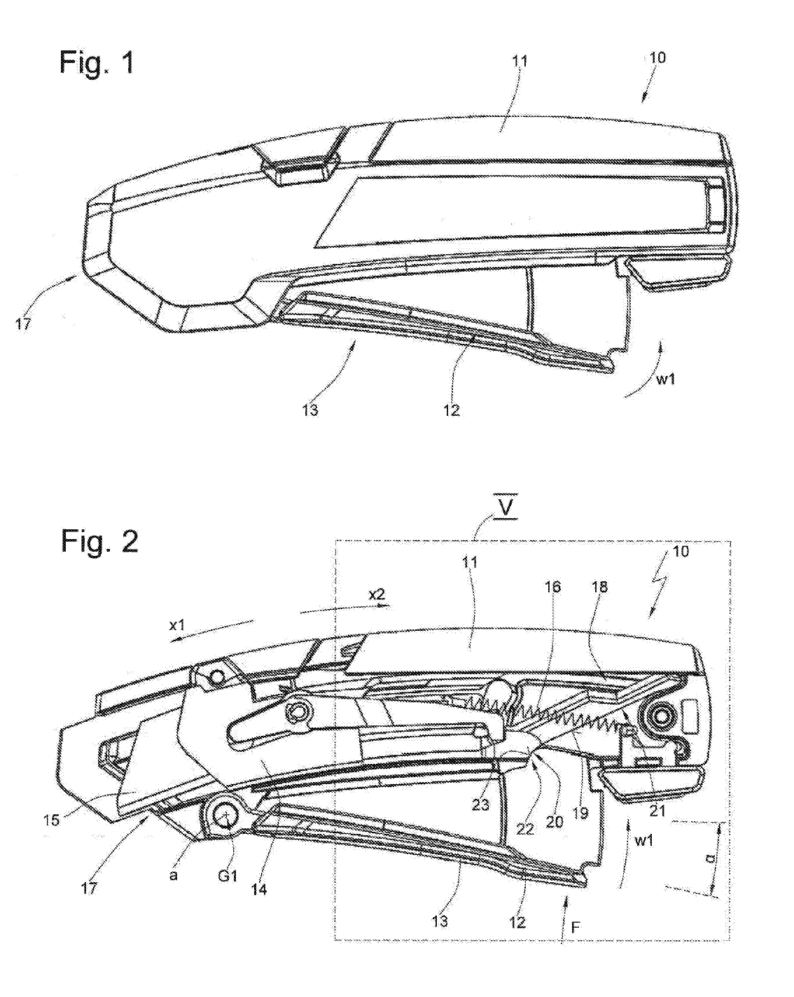

FIG. 1 is a side view of the knife in the safety position,

FIG. 2 is a longitudinal section through the knife of FIG. 1,

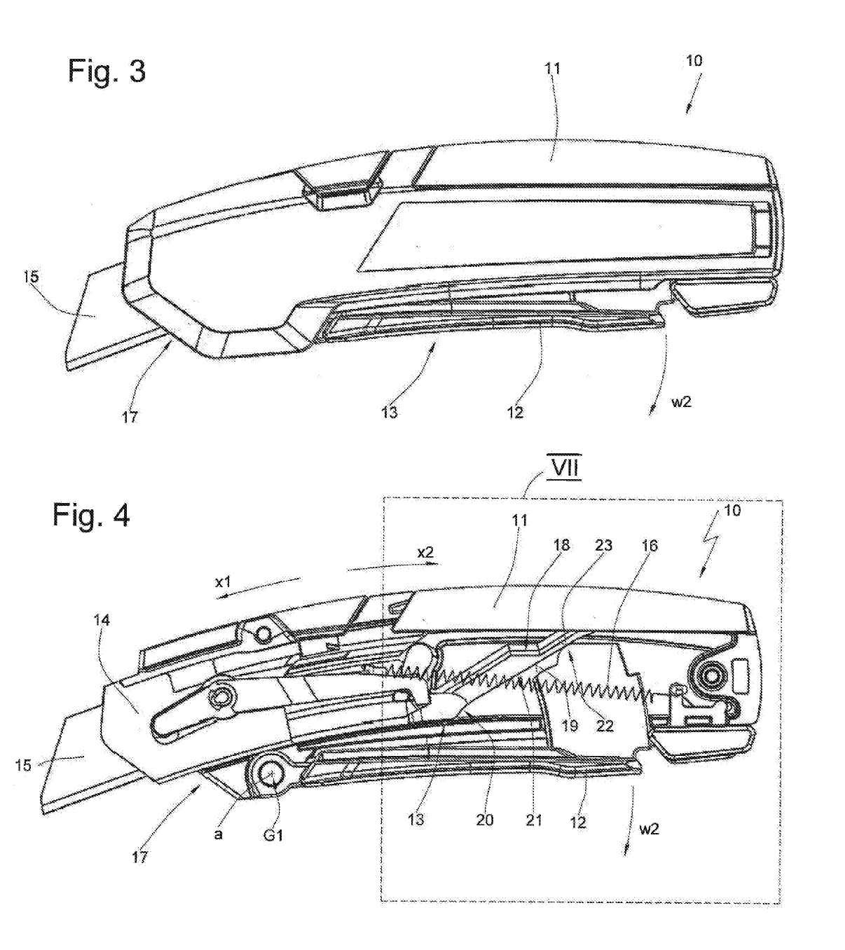

FIG. 3 is, like FIG. 1, a side view of the knife in the cutting position,

FIG. 4 is, like FIG. 2, a section through the knife in the cutting position,

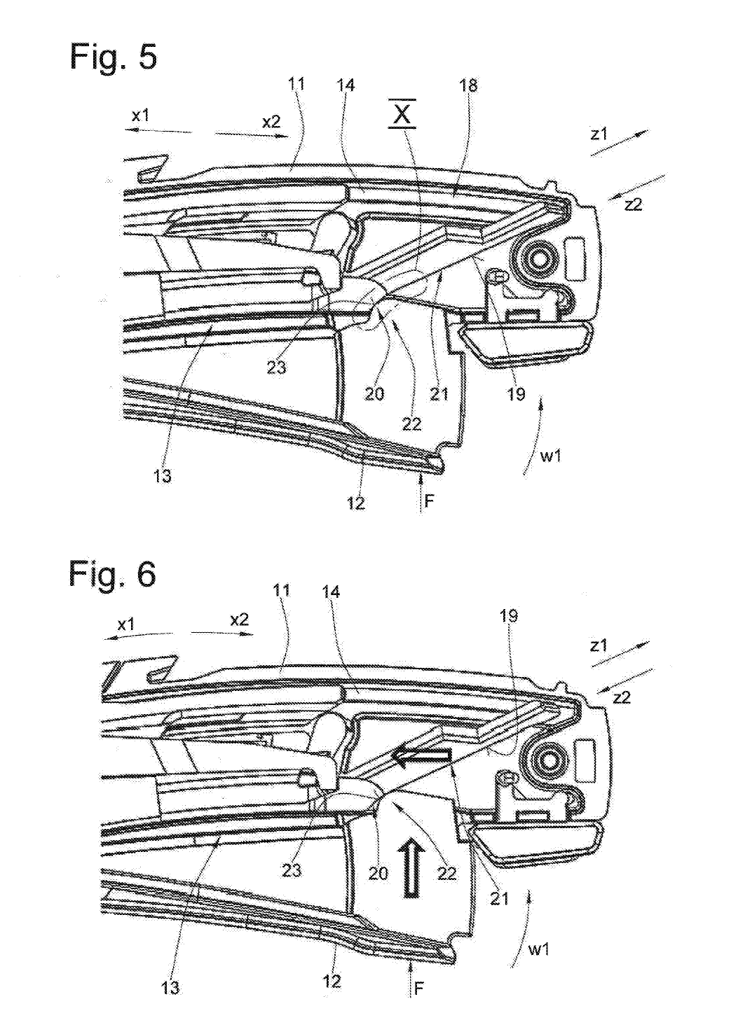

FIG. 5 is an enlarged view of a detail as shown at V in FIG. 2, a spring not being shown for sake of clarity,

FIG. 6 is a detail like FIG. 5 where the knife is in a intermediate position,

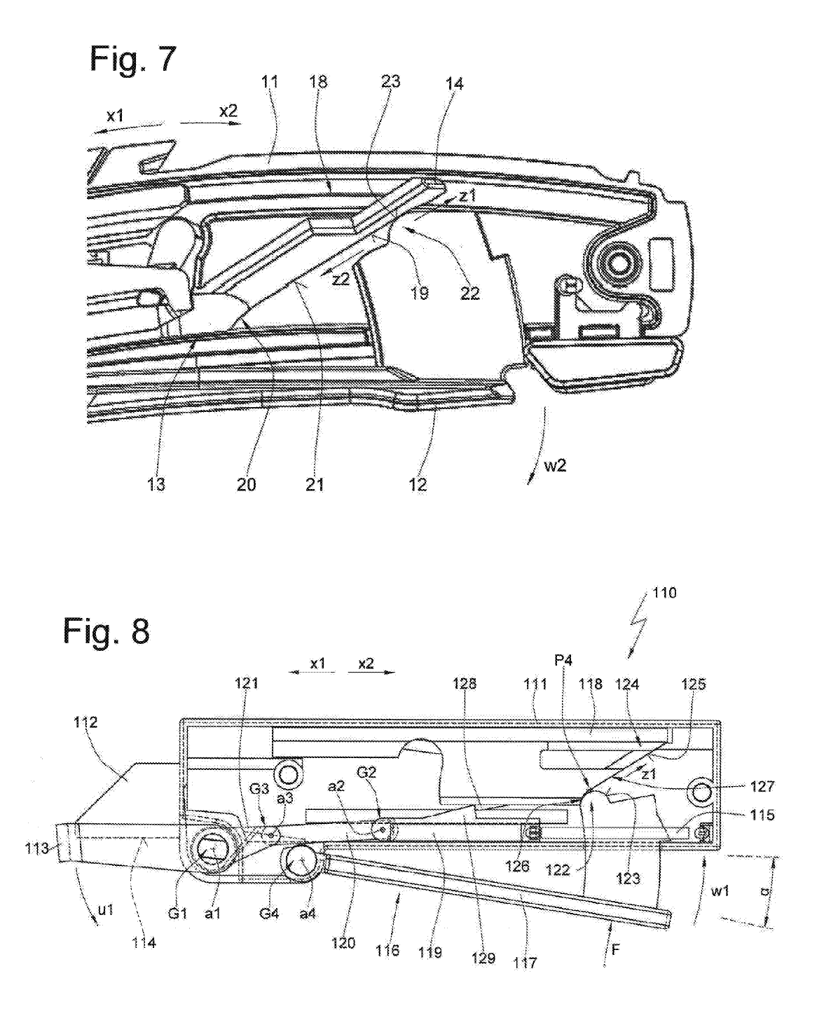

FIG. 7 is an enlarged view of detail as shown at VII in FIG. 4, a spring being omitted for sake of clarity,

FIG. 8 is a longitudinal section through a second embodiment of a knife according to the invention in the safety position,

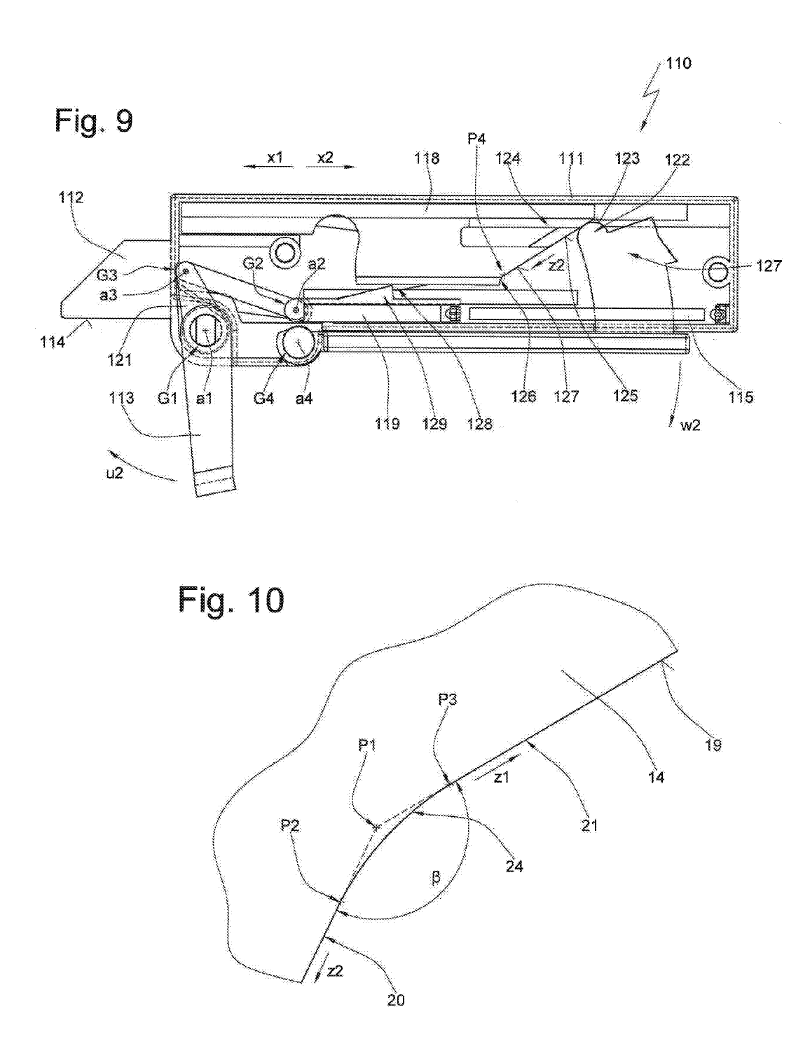

FIG. 9 is a vies like FIG. 8 but with the knife in the cutting position, and

FIG. 10 is a detail as shown at X in FIG. 5.

A knife is generally indicated at 10 in the drawing. The same reference numeral in the various figures indicate corresponding parts, even if lower-case letters are added or omitted.

The knife 10 according to FIG. 1 has a housing 11 and a handle 12. A blade holder 14 is movably mounted inside the housing 11 between at least one safety position (see FIGS. 1 and 2) and at least one cutting position (see FIGS. 3 and 4). The blade holder 14 can slide inside the housing 11. During movement of the blade holder 14 its outer surfaces interact with inner surfaces of housing 11.

In the safety position, a blade 15 held on the blade holder 14 is inside the housing 11, and in the cutting position the blade 15 projects from an opening 17 of housing 11. The handle 12 is part of an actuator 13 for moving the blade holder 14 between the safety position and the cutting position. The handle 12 is mounted on the housing 11 for pivoting about an axis a between an unactuated end position (see FIGS. 1 and 2) and a maximally actuated end position (see FIGS. 3 and 4). The handle 12 and the housing 11 form a pivot G1. The handle 12 may be rotated from the unactuated position of FIGS. 1 and 2 in a direction w1 into the actuated position shown in FIGS. 3 and 4. The handle may be rotated from the actuated position in a direction w2 into the unactuated position. An actuation projection 22 with a first actuation surface 23 is formed on the handle 12. In this embodiment, the first actuation surface 23 has a convex shape, although other shapes may also be contemplated.

The blade holder 14 has a rear extension 18 on which a second actuation surface 19 provided as a control surface is formed (see for example FIGS. 5 and 10. The second actuation surface 19 includes a first part 20 as well as a second part 21. The first part 20 and the second part 21 are generally straight and form an angle β<180°. In order to make a transition between the first part 20 to the second part 21 undetectable by the user, the actuation surface 19 forms a curved part 24 in the area of an imaginary intersection point P1 of the first part 20 with the second part 21 (see FIG. 10, for example). The curved part 24 tangentially merges with the first part 20 and the second part 21.

A spring 16 is attached to the blade holder 14 and to the housing 11 and urges the blade holder 14 in a rearward direction x2 into the safety position. The first actuation surface 23 of the handle 2 as well as the second actuation surface 19 of the blade holder 14 are kept in mutual contact by the spring 16. Between the first actuation surface 23 and the second actuation surface 19 there is linear or point contact for example. The handle 12 is rotationally urged by contact between the actuation surfaces 19 and 23 and by the spring 16 in the direction w2 into the unactuated position.

When the handle 12 is rotated by a force F from the unactuated position in the direction w1 into the actuated position, the blade holder 14 moves in a forward direction x1 into the cutting position as shown in FIGS. 3 and 4. Since movement of the blade holder 14 is along a curve, the directions x1 and x2 are movements along the curved movement path.

Rotation of the handle 12 by an angle α in the direction w1 causes the first actuation surface 23 to move with respect to the second actuation surface 19 along the first part 20 in a direction z1 up to point P2 (see, for example, FIGS. 6, 7 and 10) with the actuation surfaces 23 and 19 are in sliding contact with each other. The blade holder 14 moves against the elastic force of spring 16 by a first forward movement in the direction x1. The direction z1 and an opposite direction z2 are to be considered as directions of movement of the actuation surface 23 with respect to the actuation surface 19.

In case of further rotation of the handle 12, actuation surface 23 moves beyond the curved part 24 to the point P3.

If, starting at point P3, the handle 12 is further rotated through an angle α in the direction w1, the first actuation surface 23 moves with respect to the second actuation surface 19 in the second part 21 (see FIG. 8). The blade holder 14 is displaced by a second forward movement in the direction x1. The second forward movement is longer than the first forward movement.

In the curved part 24, the profile of the second actuation surface 19 is discontinuous, i.e. the relationship between movement of the handle 12 and movement of blade holder 14 is not constant. In the first part 20 and in the second part 21, the profile is continuous, i.e. the relationship between the movement of the handle 12 and the movement of the blade holder 14 is constant.

As soon as the user releases the handle 12, the blade holder 14 is displaced by the spring 16 in the direction x2 into the safety position, and the handle 12 is also moved back by the actuation surfaces 19 and 23 in the direction w2 into the unactuated position. When the handle 12 is released and the blade holder 14 moves back in the direction x2, the first actuation surface 23 slides in a direction z2, with respect to the second actuation surface 19.

In the above-described knife 10 for example the force F required for moving the handle 12 from the unactuated to the actuated position is approximately constant, although at the beginning of the actuation, the increased initial resistance caused by static friction has to be overcome.

A second embodiment is shown in FIGS. 9 and 10 [8 and 9]. A knife according to the second embodiment is generally indicated by reference numeral 110. The same reference numerals in various figures are applied to corresponding parts.

The knife 110 has a housing 111 and a blade 112. The blade 112 is fixed to the housing 111 not shown in detail. A blade guard 113 forms a pivot G1 with housing 111 and may be rotated between a safety position shown in FIG. 8 and a cutting position shown in FIG. 9. The blade guard 113 may rotate from the safety position around a rotation axis a1 in a direction u1 into cutting position. The blade guard 113 may also rotate around rotation axis a1 in a direction u2 into the safety position. A spring 115 urges the blade guard 113 in the safety position. In the safety position, the blade guard 113 is moved over a cutting edge 114 of blade 112 so that a user of the knife 110 cannot be injured by the cutting edge 114. In the cutting position, the blade guard 113 is rotated away from the cutting edge 114 in order to make cutting possible.

The movement between the safety and cutting positions takes place is effected by an actuator 116. The actuator 116 has a handle 117, a first slide 118, a second slide 119, and a link 120. A force-transmitting structure is formed by the first slide 118, the second slide 119, and the link 120.

The handle 117 forms with the housing 111 a pivot G4 with a rotation axis a4. The handle 117 may pivot about the rotation axis a4 between an unactuated position of FIG. 8 and an actuated position of FIG. 9.

The first slide 118 is movable in the directions x1 and x2. It can move from rear position shown in FIG. 8 in the direction x1 to a front position shown in FIG. 9. The first slide 118 may also move from the front position in the direction x2 to the rear position. The first slide 118 has a projection 128 that interacts with an abutment 129 of the second slide 119 so that the first slide 118 entrains the second slide 119 when moving in the direction x1 such that second slide 119 also moves in the direction x1. The second slide 119 is only movable in the directions x1 and x2 between positions shown in FIGS. 8 and 9. The second slide 119 forms with the link 120 a pivot G2 having a rotation axis a2. The link 120 also forms a pivot G3 having a rotation axis a3 with a lever arm 121 which is fixed to the blade guard 113.

The handle 117 has an extension 122 with a first actuation surface 123. The first slide 118 has a second actuation surface 125 at a rear end 124, and the second surface engages the first actuation surface 123. The second actuation surface 125 has a first part 126 and a second part 127. The first part 126 is curved, and the second part 127 is straight.

When the handle 117 is rotated by the force F around the rotation axis a4 from the unactuated position in the direction w1 into the actuated position, the first slide 118 is displaced in the direction x1. The projection 128 of the first slide 118 then entrains via the abutment 129 the second slide 119 in the direction x1. The link 120 is also moved in the direction x1 that rotates the lever arm 121 fixed to the blade guard 113 in the direction u1 into the cutting position.

Rotation of the handle 117 through a rotation angle α in the direction w1 causes the first actuation surface 123 to move with respect to actuation surface 125 in the first part 126 in the direction z1 up to point P4, and the blade guard 113 is moved against elastic force of spring 115, for example, by a first step in the direction x1. The directions z1 and z2 are to be considered directions of movement of the first actuation surface 123 with respect to the second actuation surface 125.

When, starting from point P4, the handle 117 is rotated by the angle of rotation α in the direction w1, and the first actuation surface 123 moves with respect to the second actuation surface 125 in the second part 127 of the second actuation surface 125, the blade guard 113 moves by a second step in the direction x1. The second step is greater than the first step.

In the first part 126, the profile of the second actuation surface 125 is discontinuous, i.e. the relationship between movement of the handle 117 and movement of the first slide 118 is not constant. In second part 127, the profile is continuous, i.e. the relationship between movement of the handle 117 and movement of the first slide 118 is constant.

The spring 115 is attached at one end to the second slide 119 and at an opposite end to the housing 111. The second slide 119 is therefore urged by the spring 115 in the direction x2. As soon as the user exerts no force on the handle 117, the second slide 119 is moved by the spring 115 in the direction x2, and the link 120 connected with the second slide 119 rotates the blade guard 113 in the direction u2. During movement of the second slide 119 in the direction x2, the first slide 118 is also moved by the abutment 129 and the projection 128 in the direction x2. During the rearward movement of first slide 118 in the direction x2, the first actuation surface 123 slides with respect to the second actuation surface 125 in the direction z2. Due to contact between surfaces 125 and 123, during back movement of first slide 118 the handle 117 is also rotated in the direction w2, into the unactuated position.

It is evident that with the inventive configuration of actuation surface as a control surface, the force/stroke ratio is adaptable to mechanical and physical conditions such that the force required to actuate the handle can be kept constant or may be varied according to ergonomic requirements, for example.

1. A knife having a housing and an actuator for moving a blade holder or a blade guard between at least one safety position and at least one cutting position, the actuator having a handle whose movement is transmissible to the blade holder or to the blade guard by the actuator that has a first actuation surface associated with the handle and a second actuation surface associated with the blade holder or the blade guard, at least one of the actuation surfaces is formed as a control surface with at least a first part and a second part.

2. The knife according to claim 1, wherein the first actuation surface during movement between safety position and cutting position, moves with respect to the second actuation surface over the first part and over the second part.

3. The knife according to claim 2, wherein a force/stroke ratio during relative movement between the first actuation surface and the second actuation surface in the first part differs from that of the second part.

4. The knife according to claim 1, wherein at least one of the parts of the control surface is formed by a curve.

5. The knife according to claim 1, wherein at least one of the parts of the control surface is straight.

6. The knife according to claim 1, wherein the first part and the second part are straight and form an angle <180°.

7. The knife according to aim 1, wherein the control surface is formed at a point between the first part and the second part as a curved part that tangentially merges with the first part and the second part.

8. The knife according to claim 1, further comprising a force-transmitting structure between the handle and the blade holder or between the handle and the blade guard.

9. The knife, claim 1, further comprising a spring urging the second actuation surface into engagement with the first actuation surface.

10. The knife according to claim 1, wherein there is sliding contact between the first actuation surface and the second actuation surface.
